(19) United States
(12) Patent Application Publication
(10) Pub. No.: US 2025/0390388 A1
(43) Pub. Date: Dec. 25, 2025

(54) DATA STORAGE SYSTEM AND METHOD

(71) Applicant: AUTOCHIPS WUHAN CO., LTD., Wuhan, Hubei (CN)

(72) Inventor: Yucheng YE, Wuhan, Hubei (CN)

(21) Appl. No.: 18/853,563

(22) PCT Filed: Mar. 27, 2023
(86) PCT No.: PCT/CN2023/084121

§ 371 Date: May 15, 2025

(30) Foreign Application Priority Data
Apr. 2, 2022 (CN) 202210344913.X

(51) Int. Cl. G06F 11/10

(52) U.S. Cl. CPC G06F 11/1068; G06F 11/1048

(57) ABSTRACT

Provided are a data storage system and method. The system includes a first memory, a second memory, and a controller. The first memory is configured to store first data or second data, the first data is first storage data, and the second data includes the first storage data and a second error correction code corresponding to second storage data; the second memory is configured to store third data or fourth data, the third data is the second storage data, and the fourth data includes the second storage data and a first error correction code corresponding to the first storage data; and the controller is further configured to control data writing and data reading of the first memory and/or the second memory. The present disclosure reduces the development difficulty of the data storage system and ensures the reading and writing efficiency of the data storage system at the same time.

### CROSS-REFERENCE TO RELATED APPLICATION

This application is a National Stage of International Application No. PCT/CN2023/084121, filed on Mar. 27, 2023, which claims the benefit of Chinese Patent Application 202210344913.X, filed Apr. 2, 2022, the disclosures of which are hereby incorporated by reference in their entirety.

### TECHNICAL FIELD

The-present disclosure relates to the technical field of memory and, in particular, to data storage system and method.

### BACKGROUND

At present, a data storage system is prone to more or less malfunctions during use, which cannot fully guarantee the reliability of stored data, so that data read/write error may occur, thereby affecting reliable operation of the system. In order to improve the reliability of the stored data in the data storage system during use, an error correction code (referred as ECC) scheme is proposed to automatically normalize and correct errors after the errors occur during a transmission process of the stored data.

In the prior art, there are two types of ECC schemes, one is sideband ECC and the other is inline ECC. In the sideband ECC scheme, the ECC, as sideband data, is sent to an internal storage together with actual data. For example, for a 32-bit data width, 7 additional bits are used for ECC storage, so a 32-bit data ECC requires a 39-bit memory bit width. The inline ECC scheme has a fixed channel width, and stores an ECC code in a real data storage space. Therefore, a storage space of the memory needs to be partitioned so as to allocate a dedicated portion of the internal storage to an ECC value for storage.

There are the following problems in the prior art: the sideband ECC scheme needs to extend the memory bit width and requires a specific memory, so that there is usually no corresponding memory in some low-cost and common processes, increasing the development difficulty. The inline ECC scheme needs to generate separate read and write commands for the ECC code, which reduces the reading and writing efficiency of the memory.

### SUMMARY

In view of this, it is necessary to provide a data storage system and method in order to solve the technical problem in the prior art that an expansion of a memory bit width cannot be avoided while ensuring the reading and writing efficiency of the data storage system, in order to reduce the development difficulty of the data storage system.

In order to solve the foregoing technical problem, the present disclosure provides a data storage system, including: a first memory, a second memory and a controller; where the first memory is configured to store first data or second data, the first data is first storage data, and the second data includes the first storage data and a second error correction code corresponding to second storage data; the second memory is configured to store third data or fourth data, the third data is the second storage data, and the fourth data includes the second storage data and a first error correction code corresponding to the first storage data; and the controller is configured to control data writing and data reading of the first memory and/or the second memory.

In some possible embodiments, the data storage system further includes an enable determining module configured to determine whether an error correction code is enabled according to configuration information; when the error correction code is enabled, the controller is configured to generate the first error correction code according to the first storage data, and/or to generate the second error correction code according to the second storage data, the first memory is configured to store the first storage data and the second error correction code, and the second storage is configured to store the second storage data and the first error correction code; and when the error correction code is not enabled, the first memory is configured to store the first storage data and the second memory is configured to store the second storage data.

In some possible embodiments, the first memory includes a first data storage area and a first error correction code storage area, and the second memory includes a second data storage area and a second error correction code storage area; when the error correction code is enabled, the first data storage area is configured to store the first storage data, the first error correction code storage area is configured to store the second error correction code; and the second data storage area is configured to store the second storage data, the second error correction code storage area is configured to store the first error correction code; and when the error correction code is not enabled, the first data storage area and the first error correction code storage area are configured to store the first storage data; and the second data storage area and the second error correction code storage area are configured to store the second storage data.

In some possible embodiments, the controller includes a read/write timing sub-controller and an encoding sub-controller; where the read/write timing sub-controller is configured to determine a data processing status of the first memory and the second memory, the data processing status includes a data writing status and a data reading status; and the encoding sub-controller is configured to, when the error correction code is enabled and the first memory and the second memory are in the data writing status, store the first storage data into the first data storage area, and store the first error correction code into the second error correction code storage area within a same instruction cycle; or store the second storage data into the second data storage area, and store the second error correction code into the first error correction code storage area within the same instruction cycle.

In some possible embodiments, the controller further includes a decoding sub-controller; where the decoding sub-controller is configured to, when the error correction code is enabled and the first memory and the second memory are in the data reading status, read the first storage data from the first data storage area, and read the first error correction code from the second error correction code storage area within the same instruction cycle; or read the second storage data from the second data storage area, and read the second error correction code from the first error correction code storage area within the same instruction cycle.

In some possible embodiments, a storage space of the first data storage area is larger than or equal to that of the first error correction code storage area, and a storage space of the second data storage area is larger than or equal to that of the second error correction code storage area.

In some possible embodiments, spatial addresses of the first memory and the second memory are contiguous.

In some possible embodiments, the data storage system further includes a third memory and a fourth memory; where the third memory is configured to store fifth data or sixth data, the fifth data is third storage data and the sixth data includes the third storage data and a fourth error correction code corresponding to fourth storage data; and the fourth memory is configured to store seventh data or eighth data, the seventh data is the fourth storage data and the eighth data includes the fourth storage data and a third error correction code corresponding to the third storage data.

In some possible embodiments, spatial addresses of the first memory, the second memory, the third memory, and the fourth memory are sequentially contiguous; or spatial addresses of the first memory, the third memory, the second memory, and the fourth memory are sequentially contiguous.

In another aspect, the present disclosure further provides a data storage method, including: controlling a first memory to store first storage data or store the first storage data and a second error correction code corresponding to second storage data; and controlling a second memory to store the second storage data or store the second storage data and a first error correction code corresponding to the first storage data.

The beneficial effects of the above embodiments are as follows: for the data storage system provided in the present disclosure, the data storage system is provided to include the first memory and the second memory, and the first memory is provided to store the first storage data and the second error correction code and the second memory is provided to store the second storage data and the first error correction code, so that the error correction of data reading and writing in the data storage system can be ensured by using only two general-purpose memories without reducing the read/write efficiency of the memories, and there is no need to expand the bit widths of the general-purpose memories, thereby reducing the implementation cost of the error correction function of the data storage system, and ensuring the reading and writing efficiency while implementing the error correction function.

### BRIEF DESCRIPTION OF THE DRAWINGS

In order to illustrate the technical solutions in the embodiments of the present disclosure more clearly, a brief description will be given to the accompanying drawings required for the embodiments below. Obviously, the accompanying drawings in the following description are merely some embodiments of the present disclosure, and for those skilled in the art, other drawings can also be obtained from these drawings without creative efforts.

FIG. 1 is a schematic structural diagram of a first embodiment of a data storage system according to the present disclosure.

FIG. 2 is a schematic structural diagram of a second embodiment of the data storage system according to the present disclosure.

FIG. 3 is a schematic structural diagram of a third embodiment of the data storage system according to the present disclosure.

FIG. 4 is a schematic flowchart of an embodiment of a data storage method according to the present disclosure.

### DESCRIPTION OF EMBODIMENTS

The technical solutions in the embodiments of the present disclosure are hereinafter described in detail with reference to the accompanying drawings. Obviously, the described embodiments are merely some rather than all of the embodiments of the present disclosure. Based on the embodiments of the present disclosure, all other embodiments obtained by those ordinary skilled in the art based on the embodiments of the present disclosure without creative efforts shall fall within the protection scope of the present disclosure.

It should be noted that in the description of present disclosure, the terms such as “first” and “second”, etc. are only used for description, and cannot be understood as indicating or implying relative importance or implicitly indicating the quantity of the indicated technical features. Therefore, the features defined by “first” and “second” may explicitly or implicitly include one or more of such features. In the description of the embodiments of the present disclosure, the “a plurality of” means two or more than two, unless otherwise specifically defined.

Some of the block diagrams shown in the accompanying drawings are functional entities, and may not necessarily correspond to physically or logically independent entities. The functional entities may be implemented in a software form, or in one or more hardware modules or integrated circuits, or in various networks and/or processor systems and/or microcontroller systems.

In the embodiments of the present disclosure, the terms “include”, “have” and any variation thereof are intended to encompass a non-exclusive inclusion, for example, a process, a method, an apparatus, a product or a device that includes a series of steps or modules is not limited to those steps or modules listed clearly, but may include other steps or modules not listed clearly or inherent to the process, the method, the product or the device.

The naming or numbering of the steps in the embodiments of the present disclosure does not mean that the steps in the method flow must be executed according to a time/logic precedence order indicated by the naming or numbering. The named or numbered process steps can be changed in execution order according to the technical objectives to be achieved, as long as the same or similar technical effect can be achieved.

Reference in the present disclosure to “embodiment” means that specific features, structures, or characteristics described in connection with the embodiment may be included in at least one embodiment of the present disclosure. The phrase appearing in various places of the specification are not necessarily all referring to the same embodiment, and also are not independent or alternative embodiments that is mutually exclusive with other embodiments. It may be understood explicitly and implicitly by those skilled in the art that the described embodiments of the present disclosure can be combined with other embodiments.

The present disclosure provides a data storage system and method, which will be described below.

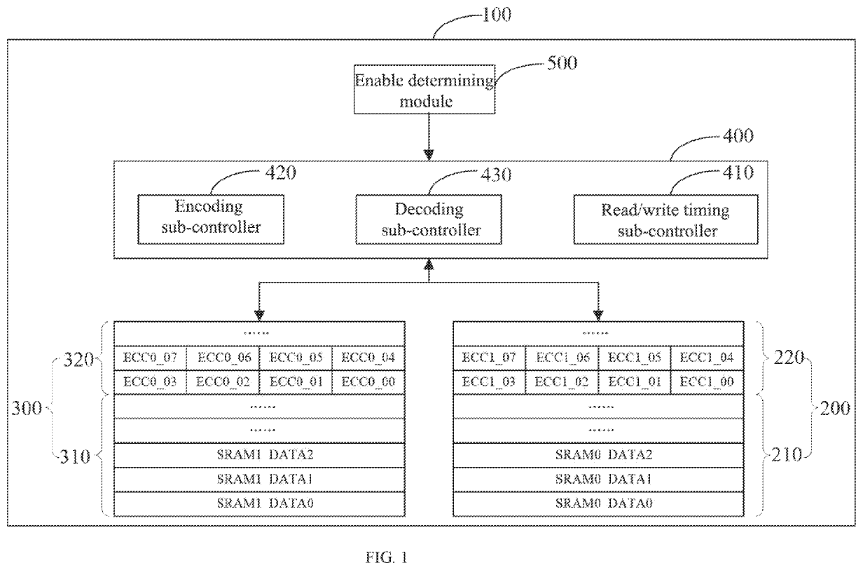

FIG. 1 is a schematic structural diagram of an embodiment of the data storage system according to the present disclosure. As shown in FIG. 1, the data storage system 100 comprises: a first memory 200, a second memory 300, and a controller 400; where the first memory 200 is configured to store first data or second data, where the first data is first storage data, and the second data includes the first storage data and a second error correction code corresponding to second storage data; the second memory 300 is configured to store third data or fourth data, where the third data is the second storage data, and the fourth data includes the second storage data and a first error correction code corresponding to the first storage data; and the controller 400 is configured to control data writing and data reading of the first memory 200 and/or the second memory 300.

Compared with the prior art, for the data storage system 100 provided in the embodiments of the present disclosure, the data storage system 100 is provided to include the first memory 200 and the second memory 300, and the first memory 200 is provided to store the first storage data and the second error correction code and the second memory 300 is provided to store the second storage data and the first error correction code, so that the error correction of data reading and writing in the data storage system 100 can be ensured by using only two general-purpose memories without reducing the read/write efficiency of the memories, and there is no need to expand the bit widths of the general-purpose memories, thereby reducing the implementation cost of the error correction function of the data storage system 100, and ensuring the reading and writing efficiency while implementing the error correction function.

In some embodiments of the present disclosure, specifications of the first memory 200 and the second memory 300 are the same, where the first memory 200 and the second memory 300 may be any one of a static random access memory (referred as SRAM), a dynamic random access memory (referred as DRAM), and a ferroelectric random access memory (referred as FRAM).

In a specific embodiment of the present disclosure, the first memory 200 and the second memory 300 are SRAM.

In some embodiments of the present disclosure, as shown in FIG. 1, the data storage system 100 further comprises an enable determining module 500, where the enable determining module 500 is configured to determine whether an error correction code is enabled according to configuration information;

when the error correction code is enabled, the controller 400 is configured to generate the first error correction code according to the first storage data, and/or to generate the second error correction code according to the second storage data, the first memory 200 is configured to store the first storage data and the second error correction code, and the second storage 300 is configured to store the second storage data and the first error correction code; and when the error correction code is not enabled, the first memory 200 is configured to store the first storage data and the second memory 300 is configured to store the second storage data.

It should be noted that, the configuration information has been determined before the data storage system 100 performs data writing or reading, the configuration information is stored in a non-volatile memory (referred as NVM), so as to ensure that the configuration information does not disappear with power-off of the data storage system 100, and the configuration information cannot be modified during the data storage system 100 performs data writing or reading.

In some embodiments of the present disclosure, as shown in FIG. 1, the first memory 200 includes a first data storage area 210 and a first error correction code storage area 220, and a second memory 300 includes a second data storage area 310 and a second error correction code storage area 320; when the error correction code is enabled, the first data storage area 210 is configured to store the first storage data, the first error correction code storage area 220 is configured to store the second error correction code; and the second data storage area 310 is configured to store the second storage data, the second error correction code storage area 320 is configured to store the first error correction code.

Specifically, when the error correction code is enabled, the first storage data may include SRAM0 DATA0, SRAM0 DATA1 and SRAM0 DATA2, and then the first error correction code includes ECC0_00, ECC0_01 and ECC0_02 corresponding to SRAM0 DATA0, SRAM0 DATA1 and SRAM0 DATA2, respectively, where SRAM0 DATA0, SRAM0 DATA1, and SRAM0 DATA2 are stored in the first data storage area 210, and ECC0_00, ECC0_01, and ECC0 02 are stored in the second error correction code storage area 320.

Similarly, when the error correcting code is enabled, the second storage data may include SRAM1_DATA0, SRAM1 DATA1 and SRAM1 DATA2, and then the second error correcting code includes ECC1_00, ECC1-01 and ECC1-02 corresponding to SRAM1 DATA0, SRAM1 DATA1 and SRAM1 DATA2, respectively, where SRAM1 DATA0, SRAM1 DATA1, and SRAM1 DATA2 are stored in the second data storage area 310, and ECC1_00, ECC1_01, and ECC1-02 are stored in the first error correction code storage area 220.

In order to avoid waste of the first error correction code storage area 220 and the second error correction code storage area 320 when the error correction code is not enabled, in some embodiments of the present disclosure, when the error correction code is not enabled, both the first data storage area 210 and the first error correction code storage area 220 are configured to store first storage data; and the second data storage area 310 and the second error correction code storage area 320 are both configured to store the second storage data.

Through the above configuration, when the error correction code is not enabled, an internal storage waste of the first memory 200 and the second memory 300 is avoided.

In some embodiments of the present disclosure, as shown in FIG. 1, the controller 400 includes a read/write timing sub-controller 410 and an encoding sub-controller 420; where the read/write timing sub-controller 410 is configured to determine a data processing status of the first memory 200 and the second memory 300, the data processing status includes a data writing status and a data reading status; and the encoding sub-controller 420 is configured to, when the error correction code is enabled and the first memory 200 and the second memory 300 are in writing status writing status, store the first storage data into the first data storage area 210, and store the first error correction code into the second error correction code storage area 320 within a same instruction cycle; or store the second storage data into the second data storage area 310, and store the second error correction code into the first error correction code storage area 220 within the same instruction cycle.

In some embodiments of the present disclosure, as shown in FIG. 1, the controller 400 further includes a decoding sub-controller 430, where the decoding sub-controller 430 is configured to, when the error correction code is enabled and the first memory 200 and the second memory 300 are in writing status reading status, read the first storage data from the first data storage area 210, and read the first error correction code from the second error correction code storage area 320 within the same instruction cycle; or read the second storage data from the second data storage area 310, and read the second error correction code from the first error correction code storage area 220 within the same instruction cycle.

In order to ensure the accuracy of the read first storage data and/or second storage data, in some embodiments of the present disclosure, the decoding sub-controller 430 is further configured to verify the read first error correction code and second error correction code.

Specifically, the decoding sub-controller 430 is configured to verify whether the read first error correction code is consistent with the first error correction code stored in the second error correction code storage area 320 by the encoding sub-controller 420. If they are consistent, it indicates that the first storage data is accurate, and if they are inconsistent, it indicates that the read first storage data is abnormal, and a prompt message is generated to prompt an operating user. Similarly, the decoding sub-controller 430 is further configured to verify whether the read second error correction code is consistent with the second error correction code stored in the first error correction code storage area 220 by the encoding sub-controller 420. If they are consistent, it indicates that the second storage data is accurate, and if they are inconsistent, it indicates that the read second storage data is abnormal, and the prompt message is generated to prompt the operating user.

In some embodiments of the present disclosure, a storage space of the first data storage area 210 is larger than or equal to that of the first error correction code storage area 220; and a storage space of the second data storage area 310 is larger than or equal to that of the second error correction code storage area 320.

It should be understood that, a ratio of the storage space of the first data storage area 210 to that of the first error correction code storage area 220 should be adjusted according to a bit number of the first storage data and that of the second error correction code, and a ratio of the storage space of the second data storage area 310 to that of the second error correction code storage area 320 should be adjusted according to a bit number of the second storage data and that of the first error correction code, and which are not repeated herein one by one.

In some embodiments of the present disclosure, when the first storage data and the second storage data are 32 bits, the ratio of the storage space of the first data storage area 210 to that of the first error correction code storage area 220 is 4, and the ratio of the storage space of the second data storage area 310 to that of the second error correction code storage area 320 is 4.

This is because when the first storage data and the second storage data are 32 bits, the first error correction code and the second error correction code are 7 bits respectively, so that the ratio of the storage space of the first data storage area 210 to that of the first error correction code storage area 220 is 4, and the ratio of the storage space of the second data storage area 310 to that of the second error correction code storage area 320 is 4.

It should be noted that, the way of writing the first error correction code into the second error correction code storage area 320 or reading the first error correction code from the second error correction code storage area 320, and the way of writing the second error correction code into the first error correction code storage area 220 or reading the second error correction code from the first error correction code storage area 220 are both byte access ways.

In some embodiments of the present disclosure, spatial addresses of the first memory 200 and the second memory 300 are contiguous.

In the embodiment of the present disclosure, by setting the space addresses of the first memory 200 and the second memory 300 to be continuous, the internal storage waste can be further avoided.

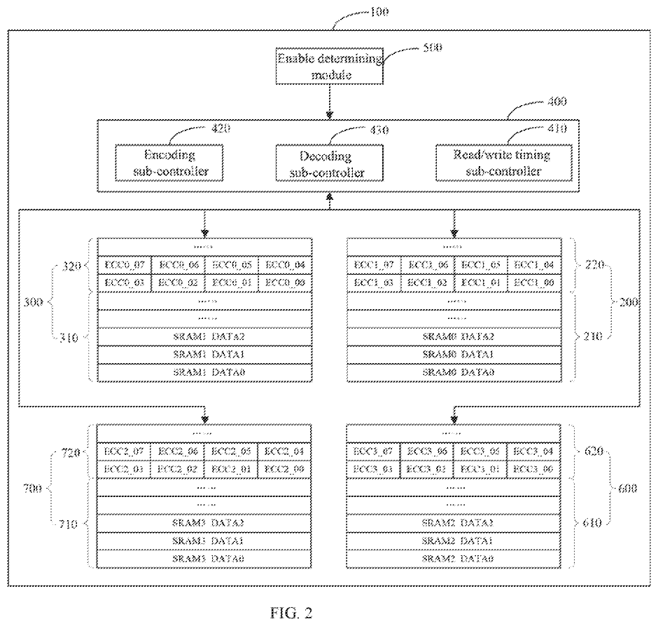

In order to improve the internal storage of the data storage system 100 so as to enhance the data storage capacity of the data storage system 100, in some embodiments of the present disclosure, as shown in FIG. 2, the data storage system 100 further includes a third memory 600 and a fourth memory 700; where the controller 400 is configured to receive third storage data stored in the third memory 600 and/or fourth storage data stored in the fourth memory 700; the controller 400 is configured to generate a third error correction code according to the third storage data, and/or generate a fourth error correction code according to the fourth storage data; the third memory 600 is configured to store fifth data or sixth data, the fifth data is third storage data, and the sixth data includes the third storage data and a fourth error correction code; and the fourth memory 700 is configured to store seventh data or eighth data, the seventh data is fourth storage data, and the eighth data includes the fourth storage data and a third error correction code.

In the embodiments of the present disclosure, by adding the third memory 600 and the fourth memory 700 that are in the data storage system 100 and configured to store data, the internal storage of the data storage system 100 may be increased, thereby further improving the data storage capacity of the data storage system 100.

It should be understood that, the number of memories included in the data storage system 100 may be adjusted according to an actual internal storage requirement, which is not limited to four, and will not be repeated herein one by one.

In some embodiments of the present disclosure, spatial addresses of the first memory 200, the second memory 300, the third memory 600, and the fourth memory 700 are sequentially contiguous.

In other embodiments of the present disclosure, spatial addresses of the first memory 200, the third memory 600, the second memory 300, and the fourth memory 700 are sequentially contiguous.

In the embodiments of the present disclosure, by setting the foregoing two spatial address arrangement manners of the first memory 200, the second memory 300, the third memory 600, and the fourth memory 700, the flexibility of the data storage system 100 may be improved.

It should be noted that, as shown in FIG. 3, in some embodiments of the present disclosure, when the data storage system 100 includes the first memory 200, the second memory 300, the third memory 600 and the fourth memory 700, it is also possible to set the second memory 300 to store the first error correction code (ECC0_00 to ECC0_07) corresponding to the first storage data, the third memory 600 to store the second error correction code (ECC1-00 to ECC1_07) corresponding to the second storage data, the fourth memory 700 to store the third error correction code (ECC2-00 to ECC2_07) corresponding to the third storage data, and the first memory 200 to store the fourth error correction code (ECC3-00 to ECC3_07) corresponding to the fourth storage data.

It should be understood that, the storage data and the error correction code stored in each memory in the data storage system 100 may also be in other manners, which are not repeated herein one by one.

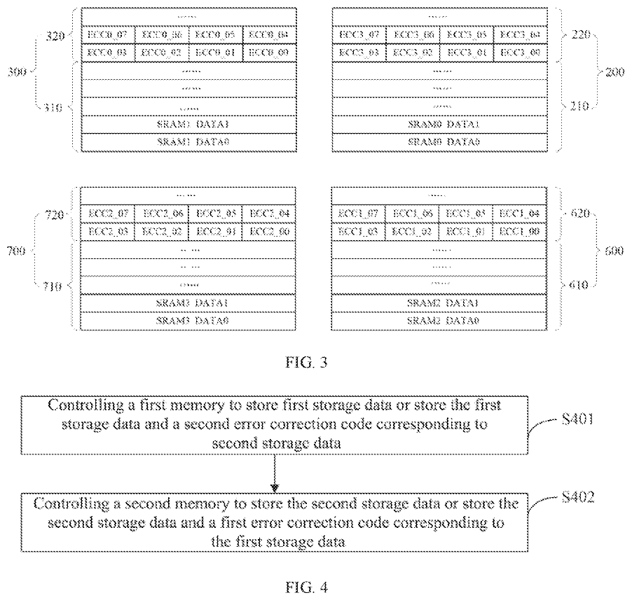

An embodiment of the present disclosure further provides a data storage method. As shown in FIG. 4, the data storage method includes: S401, controlling a first memory to store first storage data or store the first storage data and a second error correction code corresponding to second storage data; and S402: controlling a second memory to store the second storage data or store the second storage data and a first error correction code corresponding to the first storage data.

The data storage method provided in the foregoing embodiment can implement the technical solutions described in the foregoing embodiments of the data storage system. The specific implementation principle of the above steps can be found in the corresponding content of the foregoing embodiments of the data storage system, which will not be repeated herein.

Those skilled in the art may understand that all or part of the processes of the method according to the embodiments may be implemented by instructing relevant hardware through a computer program, which may be stored in a computer readable storage medium. The computer readable storage medium may be a magnetic disk, an optical disk, a read-only memory, or a random access memory.

The foregoing contents describe the data storage system and method provided by the present disclosure in detail. Specific examples are used in the present disclosure to describe the principles and embodiments of the present disclosure. The description of the foregoing embodiments is merely used to help understand the method and core idea of the present disclosure. At the same time, those skilled in the art may make modifications to the specific implementations and application scopes based on the idea of the present disclosure. In summary, the content of the specification shall not be understood as a limitation to the present disclosure.

1. A data storage system, comprising: a first memory, a second memory and a controller;
wherein the first memory is configured to store first data or second data, the first data is first storage data, and the second data comprises the first storage data and a second error correction code corresponding to second storage data;
the second memory is configured to store third data or fourth data, the third data is the second storage data, and the fourth data comprises the second storage data and a first error correction code corresponding to the first storage data; and
the controller is configured to control data writing and data reading of the first memory and/or the second memory.

2. The data storage system according to claim 1, wherein the data storage system further comprises a processor configured to determine whether an error correction code is enabled according to configuration information;
when the error correction code is enabled, the controller is configured to generate the first error correction code according to the first storage data, and/or to generate the second error correction code according to the second storage data, the first memory is configured to store the first storage data and the second error correction code, and the second storage is configured to store the second storage data and the first error correction code; and
when the error correction code is not enabled, the first memory is configured to store the first storage data and the second memory is configured to store the second storage data.

3. The data storage system according to claim 2, wherein the first memory comprises a first data storage area and a first error correction code storage area, and the second memory comprises a second data storage area and a second error correction code storage area;
when the error correction code is enabled, the first data storage area is configured to store the first storage data, the first error correction code storage area is configured to store the second error correction code; and the second data storage area is configured to store the second storage data, the second error correction code storage area is configured to store the first error correction code; and
when the error correction code is not enabled, the first data storage area and the first error correction code storage area are configured to store the first storage data; and the second data storage area and the second error correction code storage area are configured to store the second storage data.

4. The data storage system according to claim 3, wherein the controller comprises a read/write timing sub-controller and an encoding sub-controller;
wherein the read/write timing sub-controller is configured to determine a data processing status of the first memory and the second memory, the data processing status comprises a data writing status and a data reading status; and
the encoding sub-controller is configured to, when the error correction code is enabled and the first memory and the second memory are in the data writing status, store the first storage data into the first data storage area, and store the first error correction code into the second error correction code storage area within a same instruction cycle; or store the second storage data into the second data storage area, and store the second error correction code into the first error correction code storage area within the same instruction cycle.

5. The data storage system according to claim 4, wherein the controller further comprises a decoding sub-controller; wherein the decoding sub-controller is configured to, when the error correction code is enabled and the first memory and the second memory are in the data reading status, read the first storage data from the first data storage area, and read the first error correction code from the second error correction code storage area within the same instruction cycle; or read the second storage data from the second data storage area, and read the second error correction code from the first error correction code storage area within the same instruction cycle.

6. The data storage system according to claim 3, wherein a storage space of the first data storage area is larger than or equal to that of the first error correction code storage area, and a storage space of the second data storage area is larger than or equal to that of the second error correction code storage area.

7. The data storage system according to claim 1, wherein spatial addresses of the first memory and the second memory are contiguous.

8. The data storage system according to claim 1, wherein the data storage system further comprises a third memory and a fourth memory;
wherein the third memory is configured to store fifth data or sixth data, the fifth data is third storage data and the sixth data comprises the third storage data and a fourth error correction code corresponding to fourth storage data; and
the fourth memory is configured to store seventh data or eighth data, the seventh data is the fourth storage data and the eighth data comprises the fourth storage data and a third error correction code corresponding to the third storage data.

9. The data storage system according to claim 8, wherein spatial addresses of the first memory, the second memory, the third memory, and the fourth memory are sequentially contiguous; or spatial addresses of the first memory, the third memory, the second memory, and the fourth memory are sequentially contiguous.

10. A data storage method, comprising:
controlling a first memory to store first storage data or store the first storage data and a second error correction code corresponding to the second storage data; and
controlling the a second memory to store the second storage data or store the second storage data and a first error correction code corresponding to the first storage data.

11. A non-transitory processor-readable storage medium in which a computer program is stored, wherein the computer program is configured to enable a processor to:
control a first memory to store first storage data or store the first storage data and a second error correction code corresponding to second storage data; and
control a second memory to store the second storage data or store the second storage data and a first error correction code corresponding to the first storage data.
